(19) United States
(12) Patent Application Publication
(10) Pub. No.: US 2014/0246868 A1
(43) Pub. Date: Sep. 4, 2014

(54) VEHICLE DOOR LATCH ASSEMBLY AND LATCH THEREFOR

(71) Applicants: Cort Corwin, Grand Haven, MI (US); Jerry Cummins, Portland, MI (US); Eric Vandenbrink, Holland, MI (US); Marcus Merideth, Westland, MI (US)

(72) Inventors: Cort Corwin, Grand Haven, MI (US); Jerry Cummins, Portland, MI (US); Eric Vandenbrink, Holland, MI (US); Marcus Merideth, Westland, MI (US)

(73) Assignee: ADAC PLASTICS, INC., Grand Rapids, MI (US)

(21) Appl. No.: 14/237,045

(22) PCT Filed: Aug. 6, 2012
(86) PCT No.: PCT/US2012/049762

§ 371 Date: May 21, 2014

Related U.S. Application Data
(60) Provisional application No. 61/515,385, filed on Aug. 5, 2011.

(51) Int. Cl. E05B 77/12; E05C 1/14; E05B 85/18; E05C 1/00

(52) U.S. Cl. CPC E05B 77/12; E05C 1/004; E05C 1/14; E05B 85/18
USPC 292/7; 292/92; 292/336.3; 292/138

(57) ABSTRACT

A vehicle door latch assembly includes a latch lever connectable to a latch mechanism, a latch rod coupled to the latch lever, and a door handle operative to effect movement of the latch rod to unlatch the latch mechanism via actuation of the latch lever. The latch rod is configured so as to attenuate vertical motion of the latch rod in response to a sufficient force associated with a side-impact event. In one embodiment, the latch rod has a first member operatively connected to the door handle, and a second member pivotally connected to the first member. The second member is coupled to the latch lever, and the-second member is pivotally movable with the latch lever laterally in a direction away from the first member in response to a sufficient force associated with a side-impact event.

### CROSS-REFERENCE TO RELATED APPLICATIONS

The present application is related to, and claims the benefit of priority from, U.S. Provisional Application Ser. No. 61/515,385, filed Aug. 5, 2011, and the disclosure of which is incorporated herein by reference in its entirety.

### FIELD OF THE INVENTION

The present disclosure relates generally to vehicle door latch assemblies and, more particularly, to a vehicle door latch assembly, and latch rod therefor, in which vertical motion of the latch rod is attenuated in response to a sufficient force associated with a side-impact event.

### BACKGROUND

Vehicle door latch assemblies generally include a handle 1 mounted on the vehicle door D, and operably connected, via a bell crank 2, to the latch lever of a latch mechanism (indicated generally at 3) by means of a latch rod 4. In the default condition of the door handle, the latch mechanism is in the position of latching the vehicle door. When a user actuates the handle (interior or exterior), the latch rod moves generally vertically downward to unlatch the latch mechanism via the latch lever and, thus, enable the vehicle door to be opened.

The operation of vehicle doors and latches is governed by regulations requiring all side and rear doors, hatches, and liftgates to remain closed during the impact sequence associated with a side-impact event such as, for example and without limitation, collision between two vehicles. After the impact event, regulations require, for vehicles with two doors per seating row, that one side door per seating row be capable of being opened without the use of tools.

In the art, there presently exist a variety of vehicle door latch assembly designs. One conventional design, shown in FIGS. 2A through 2C, is configured to facilitate installation of the door latch assembly on a vehicle door. More particularly, the door latch assembly of this design comprises a user-actuatable door handle 10 coupled to a bellcrank 20, a latch mechanism (not shown), a latch lever 30 (not shown in FIG. 2A), and a latch rod 40 coupled at a first end thereof to the bellcrank 20 and at a second end thereof to the latch lever 30. Unlike the latch rod 4 of the prior art embodiment of FIG. 1, which consists of a rigid element extending between and essentially permanently connected at its opposite ends to a bell crank and the latch lever, the lower end of the latch rod 40 according to the prior art assembly of FIGS. 2A through 2C defines an open slot 41 having a curved sidewall 42. Upon user actuation of the handle 10, as explained generally above in connection with FIG. 1, the bellcrank 20 is rotated, thereby driving the latch rod 40 downwardly in the direction of the arrow A. This movement causes corresponding movement of the latch lever 30 (which is captured in slot 41), resulting in actuation of the latch mechanism to unlatch the vehicle door.

By virtue of the slot 41 which slidably receives and captures therein the latch lever 30, this prior art door latch assembly facilitates installation of the door latch assembly on the vehicle door. Unfortunately, the design suffers from the propensity for the vehicle door to become unlatched during a side-impact event due to the configuration of the open slot 41. More particularly, and with reference being had specifically to FIG. 2C, during a side-impact event the latch lever 30 is urged by the force associated with the impact to move laterally and away from the latch rod 40 in the direction indicated by the arrow B. Encountering the curved sidewall 42 of the slot 41, the latch lever 30 is instead forced vertically downwardly by that geometry (as indicated by the sequence of latch lever positions 30′, 30″ shown in FIG. 2C), resulting in the latch mechanism's actuation and, resultantly, unlatching of the vehicle door during the impact event.

In view of the foregoing, there remains a need for a vehicle door latch assembly which reliably prevents the vehicle door from becoming unlatched during a side-impact event.

### SUMMARY

The present disclosure comprehends a vehicle door latch assembly, comprising a latch lever connectable to a latch mechanism, a latch rod coupled to the latch lever, and a user-actuatable door handle operative to effect movement of the latch rod along a generally vertical axis to unlatch the latch mechanism via actuation of the latch lever. The latch rod is configured so as to attenuate vertical motion of the latch rod in response to a sufficient force associated with a side-impact event.

In one embodiment, the invention comprehends a latch rod for a vehicle door latch assembly of the type including a door handle operative to effect movement of the latch rod along a generally vertical axis to unlatch a latch mechanism via actuation of a latch lever, the latch rod comprising: a first member having spaced apart upper and lower ends, and the first member adapted to be operatively connected to the door handle proximate the upper end; and a second member having spaced apart upper and lower ends, the first and second members pivotally connected proximate their lower ends. The second member is adapted to be coupled to the latch lever, and the second member is pivotally movable relative to the first member laterally in a direction away from the first member so that, in the condition of being coupled to the latch lever, the latch lever is laterally moveable with the second member.

Per one feature of this embodiment, the second member of the latch rod has generally vertically spaced-apart upper and lower ends, and comprises a generally vertically-extending slot dimensioned to receive and capture the latch lever therein, the slot opening away from the second member of the latch rod proximate the lower end.

Per a further feature, the first member of the latch rod has generally vertically spaced-apart upper and lower ends, the second member of the latch rod has generally vertically spaced-apart upper and lower ends, and the second member is pivotally connected to the first member proximate the lower ends of the first and second members.

According to still another feature, the first member of the latch rod includes a track dimensioned to slidably receive therein a member of the upper end of the second member of the latch rod.

Per yet another feature, the first and second members of the latch rod are each monolithic.

According to a still further feature, the second member of the latch rod is pivotally movable laterally in a direction away from the first member in both first and second directions.

In one embodiment, the invention comprehends a vehicle door latch assembly comprising: a latch lever connectable to a latch mechanism; a latch rod coupled to the latch lever; and a user-actuatable door handle operative to effect movement of the latch rod along a generally vertical axis to unlatch the latch mechanism via actuation of the latch lever. The latch rod comprises a first member operatively connected to the door handle, and a second member pivotally connected to the first member. The second member is coupled to the latch lever, and the second member is pivotally movable with the latch lever laterally in a direction away from the first member in response to a sufficient force associated with a side-impact event.

In another embodiment, there is disclosed a vehicle door latch assembly, comprising a user-actuatable door handle coupled to a bellcrank; a latch lever; and a latch rod coupled to the latch lever and the bellcrank, the latch rod operable by the door handle to move along a generally vertical axis to unlatch a latch mechanism via actuation of the latch lever, and the latch rod removably connected to the bellcrank. In response to a sufficient force associated with a side-impact event, the latch rod is disconnected from the bellcrank.

Per one feature, the bellcrank and latch rod are removably connected by interconnecting elements provided on each of the bellcrank and latch rod, the interconnecting elements characterized in that the latch rod is freely disconnected from the bellcrank only in a predefined orientation of the bellcrank and latch rod relative to each other, and only in response to a sufficient force associated with a side-impact event.

Per another feature, the interconnecting elements comprise: at least a first support provided on one of the bellcrank and latch rod, the at least first support including an opening; and at least a first projection provided on the other of the bellcrank and latch rod, the at least first projection received within the at least first support, the at least first projection dimensioned to be removed through the opening in the at least first support only when the at least first projection is in a predefined orientation relative to said opening.

According to a further feature, the interconnecting elements comprise: a pair of spaced-apart supports provided on one of the bellcrank and latch rod, each said support including an opening, and said openings being aligned; and a pair of trunnions provided on the other of the bellcrank and latch rod, the trunnions received within the pair of supports, and the trunnions dimensioned to be removed through the openings in the supports only when the tunnions are in a predefined orientation relative to said openings.

In a still further embodiment, a vehicle door latch assembly is disclosed which comprises a user-actuatable door handle connected to a handle framework; a latch lever; and a latch rod coupled to the latch lever and operable by the door handle to unlatch a latch mechanism via actuation of the latch lever. The latch rod is configured to be deformed by the door handle framework in response to a sufficient force associated with a side-impact event.

Per one feature, the latch rod comprises a generally vertically-extending slot dimensioned to receive and capture the latch lever therein, the slot defining an opening through the latch rod that is oriented so that an imaginary line extending through the opening extends in the direction of the handle; and the latch lever including at least a terminal member that is oriented to extend through the slot. In response to a sufficient force associated with a side-impact event, the at least terminal member of the latch lever is freely moveable within the slot along an axis extending through the opening.

Per another feature, the slot opens away from the latch rod proximate a lower end of the latch rod, and wherein the latch rod includes a flexible clip member extending across the open end of the slot, the flexible clip member oriented to be (i) deformable in a first direction to permit the terminal member of the latch lever to be received in the slot through the open end, and (ii) resistant to deformation in a second direction so as to prevent the terminal member of the latch lever to be removed from the slot through the open end.

According to a further feature, the latch rod is bent along its length. In response to a sufficient force associated with a side-impact event, the door handle framework impacts the latch rod proximate the bend, causing the latch rod to deform by decreasing the angle defined along the latch rod by the bend.

Per yet another embodiment, there is disclosed a user-actuatable door handle connected to a handle framework; a latch lever; and a latch rod coupled to the latch lever and operable by the door handle to unlatch a latch mechanism via actuation of the latch lever, the latch rod including a generally vertically-extending slot dimensioned to receive and capture the latch lever therein, the slot defining an opening through the latch rod that is oriented so that an imaginary line extending through the opening extends in the direction of the handle. The latch lever includes at least a terminal member that is oriented to extend through the slot. In response to a sufficient force associated with a side-impact event, the at least terminal member of the latch lever is freely moveable within the slot along an axis extending through the opening.

Per one feature, the slot opens away from the latch rod proximate a lower end of the latch rod, and wherein the latch rod includes a flexible clip member extending across the open end of the slot, the flexible clip member oriented to be (i) deformable in a first direction to permit the terminal member of the latch lever to be received in the slot through the open end, and (ii) resistant to deformation in a second direction so as to prevent the terminal member of the latch lever to be removed from the slot through the open end.

Per another feature, the latch rod is configured to be deformed by the door handle framework in response to a sufficient force associated with a side-impact event.

According to a further feature, the latch rod is bent along its length, and wherein, in response to a sufficient force associated with a side-impact event, the door handle framework impacts the latch rod proximate the bend, causing the latch rod to deform by decreasing the angle defined along the latch rod by the bend.

Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is a perspective view of one prior art vehicle latch assembly configuration in a static condition;

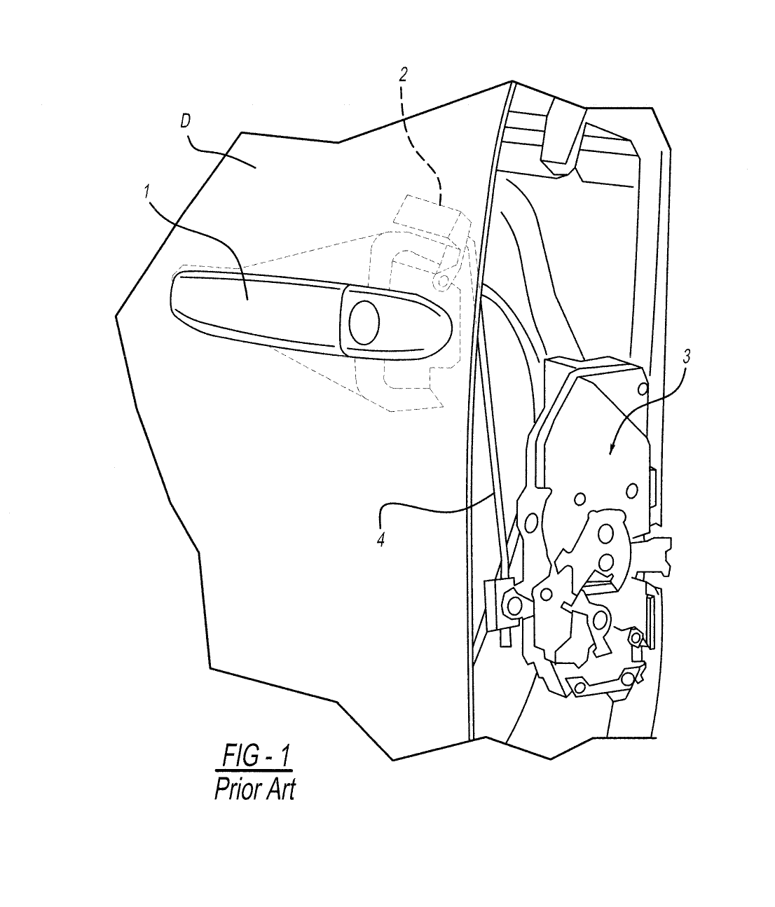

FIGS. 2A and 2B depict from perspective and lateral views, respectively, a second prior art vehicle latch assembly;

FIG. 2C depicts the prior art vehicle latch assembly of FIGS. 2A and 2B with the latch lever shown in varying positions occupied during a side-impact event;

FIG. 3 illustrates in exploded perspective a first embodiment of the latch rod of the present invention;

FIG. 4 is a perspective view of the latch rod of FIG. 3, shown in combination with a bellcrank;

FIG. 5 is a perspective view of the latch rod of FIG. 3, shown in combination with a bellcrank mounted on a handle chassis;

FIGS. 6A through 6D depict in varying operation states the latch rod of FIG. 3 in a vehicle door latch assembly according to one embodiment of the present invention (FIGS. 6B through 6D constitute mirror images of the invention as shown in FIG. 6A);

FIGS. 7A and 7B illustrates a second embodiment of a vehicle door latch assembly, including in a position (7B) occupied during a side-impact event; and

FIGS. 8A and 8B depict in alternative views a third embodiment of a door latch assembly.

### DESCRIPTION

Referring now to the drawings, wherein like numerals represent like or corresponding parts throughout the several views, the present invention may be seen to generally comprehend a vehicle door latch assembly, and latch rod therefor, the door latch assembly comprising a latch lever connectable to a latch mechanism; a latch rod coupled to the latch lever; and a user-actuatable door handle operative to effect movement of the latch rod along a generally vertical axis to unlatch the latch mechanism via actuation of the latch lever. The latch rod is configured so as to attenuate vertical motion of the latch rod in response to a sufficient force associated with a side-impact event.

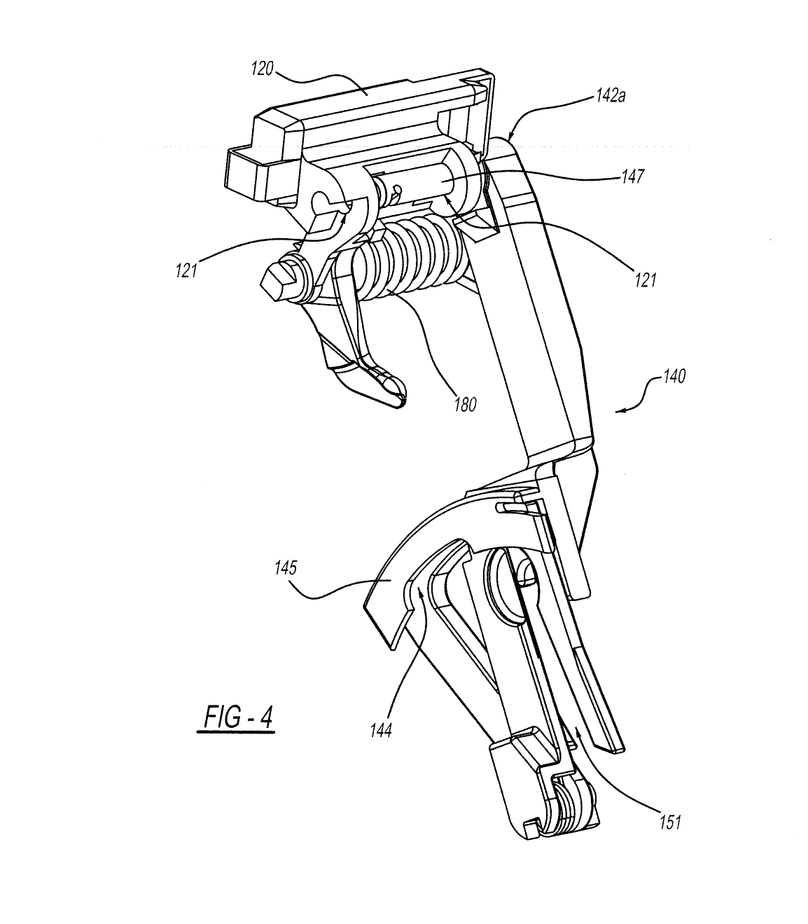

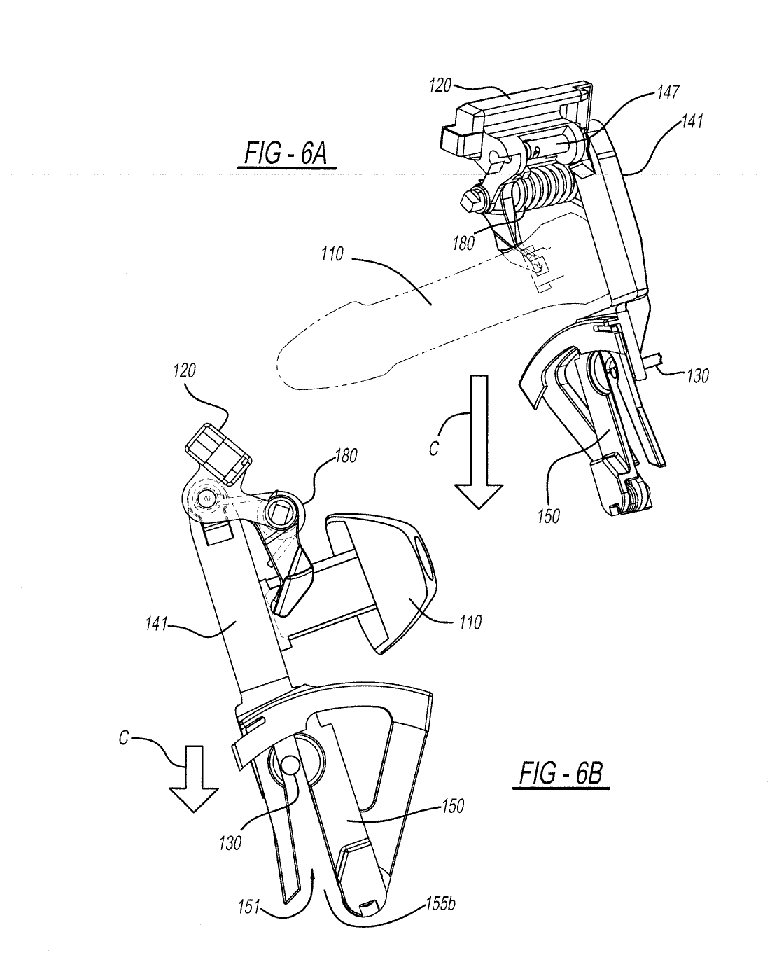

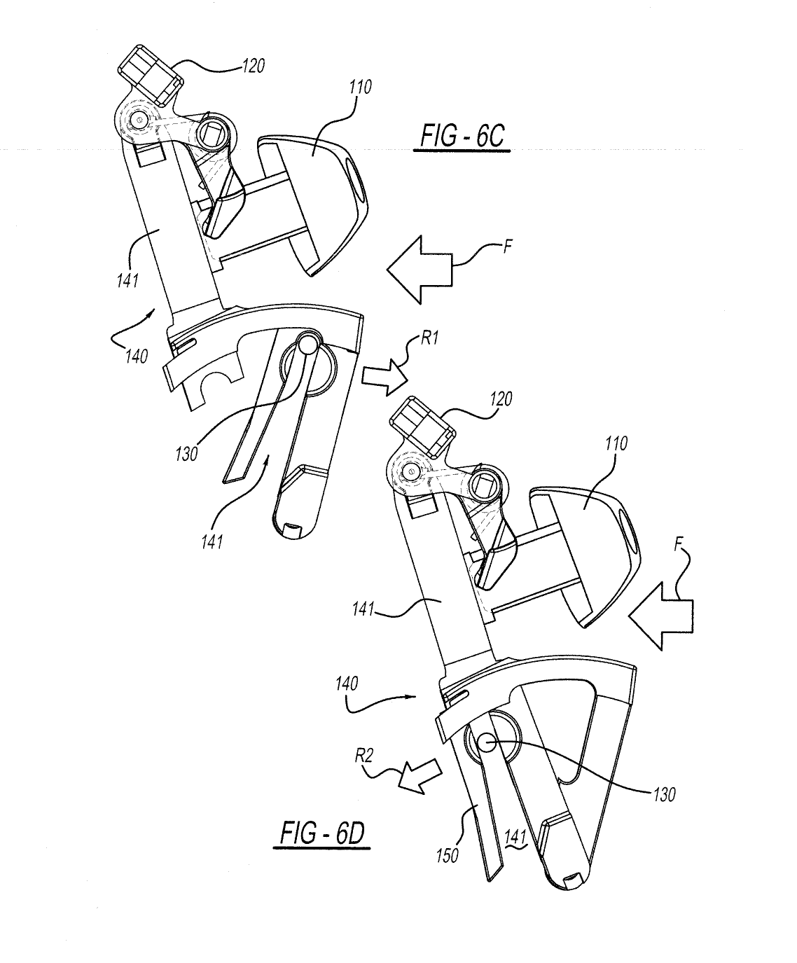

In a first embodiment thereof of a latch rod and door latch assembly incorporating the same, shown variously in FIGS. 3 through 6C, the present invention comprises a latch rod (indicated generally at 140) coupled to the latch lever 130 (shown in FIGS. 5 through 6D) of a latch mechanism (not shown) and operable by a door handle 110 (shown in FIGS. 6A through 6D) to move along a generally vertical axis C to unlatch the latch mechanism via actuation of the latch lever 130.

More particularly, and with continued reference to the embodiment of FIGS. 3 through 6D, latch rod 140 is coupled to a bellcrank 120 at a first end and, spaced apart therefrom, defines an open slot 151 in which the latch lever 130 is captured. Slot 151 includes a slightly curved or angled sidewall, as shown, so that the slot opening 155b is wider than the interior or the slot, thereby facilitating installation of the latch rod during vehicle assembly, as is known in the art.

While the term “latch rod” is used herein, as a matter of convention, in reference to the various embodiments of the present invention, it will be appreciated that the latch rod is not, and need not be, in the shape of a rod.

The latch mechanism (not shown) may be of any conventional design and construction which operates via a latch lever or comparable component(s) coupled to a latch rod.

With continued reference to FIGS. 3 through 6D, the latch rod 140 of the illustrated embodiment comprises first 141 and second 150 members. The first member 141 has spaced apart upper 142a and lower 142b ends, while the second member 150 has spaced apart upper 152a and lower ends 152b. The first and second members 141, 150 are pivotally connected proximate their lower ends 142b, 152b. More particularly, second member 150 includes a stem or post 153 received in an opening 143 through the first member 141. To secure the stem 153 in the opening 143, stem 153 includes at a terminal end a radial projection 154. Opening 143 is shaped to receive radial projection 154 therethrough in a predetermined orientation of the second member 150. According to the illustrated embodiment, the predetermined orientation, as best shown in FIG. 3, is a rotational orientation of the second member 150 which is not achieved during normal operation of a door latch assembly comprising the latch rod. Once the post 153 is fully received in the opening 143, radial projection 154 resides entirely on the side of the first member 141 opposite the rest of the second member 150 so that, when the second member 150 is rotated from its insertion orientation, radial projection 154 abuts the first member 141 to prevent withdrawal of the second member 150 therefrom.

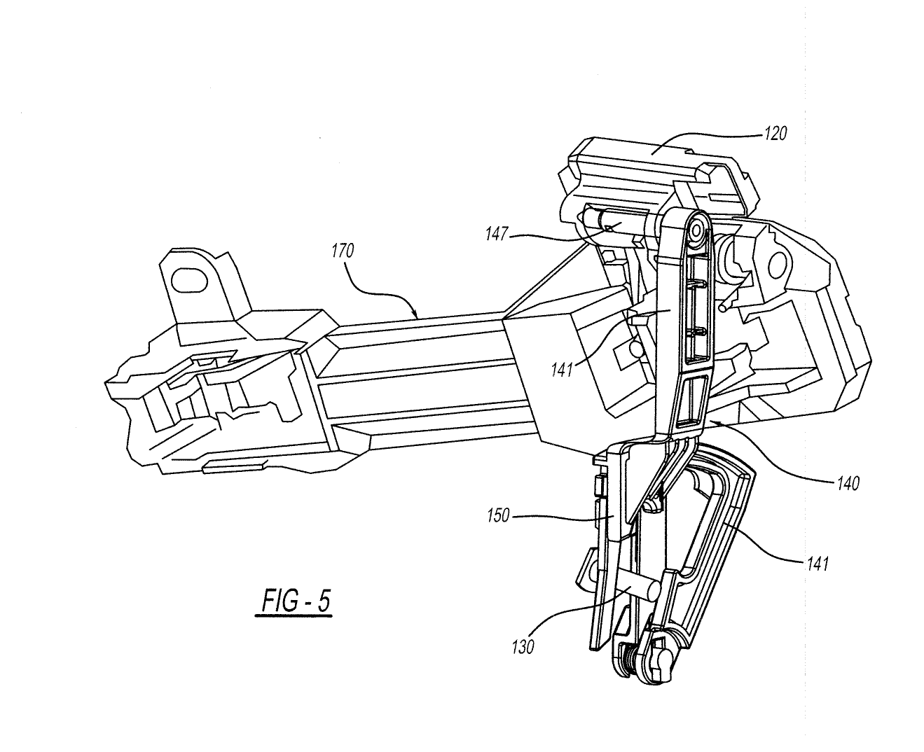

A biasing member 160, such as the illustrated torsion spring, is disposed on the post 153 and captured between the first 141 and second 150 members of the latch rod. Biasing member 160 serves to urge the second member 150 into a default rotational position (best shown in FIG. 4 and characterized by general alignment in parallel of the longitudinal axes of the slot 151 and first member 141) relative to the first member 141.

The second member 150 is adapted to be coupled to the latch lever 130 so as to effect movement thereof when movement of the latch rod is effected by actuation of the handle. As shown, slot 151 is defined in the second member 150 and includes a closed end 155a and an open end 155b. As discussed elsewhere, slot 141 is dimensioned to slidably receive therein the latch lever 130.

An arcuate track or channel 144 is defined on the first member 141 proximate the upper end 152a of second member 150, the track 144 being defined more particularly by an outwardly projecting wall 145 of generally L-shaped cross-section. The upper end 152a of second member 150 is freely received in channel 144 and is slidable therein during pivotal movement of second member 150.

Optionally, one or more stops 146 may be disposed along an interior surface of the track or channel 144 to limit the degree of travel of the second member 150 relative to the first member 141. As may be appreciated best in reference to FIG. 3, stop 146 includes a surface disposed in opposition to a corresponding stop 156 provided on the second member 150. Furthermore, stop 146 includes an opposite, ramped surface so that, in assembly of the latch rod 140, second member 150 may be urged past the stop 146 and into the track or channel 144.

As noted, the first member 141 is adapted to be operatively connected to the door handle 110 proximate the upper end 142a. Per the illustrated embodiment, such interconnection is effected between the latch rod 140 and bellcrank 120 (which is, in turn, supported on a handle chassis or framework 170 (shown in FIG. 5) for interaction with the door handle in known fashion). The interconnection is achieved in part by a post 147 provided proximate the upper end 142a and extending generally normal to the longitudinal axis of the principal length of the first member 141. As depicted best in FIGS. 3 through 6A, post 147 is rotatably received in one or more correspondingly-shaped openings 121 provided on the bellcrank 120. A free end of bias means such as the illustrated torsion spring 180 is received in a slot or opening 148 provided in the post 147 to fixedly connect the latch rod 140 to bellcrank 120. Spring 180 or other bias means also serves to bias latch rod 140 and bellcrank 120 to default orientations relative to each other.

Of course, other interconnecting configurations between the bellcrank 120 and first member 141 are possible, depending upon such consideration as the design of the bellcrank, constraints of the physical space in which the bellcrank and latch rod are disposed, etc.

First 141 and second 150 members may be fabricated from any suitable materials, including metals and plastics or other polymers. As shown, one or both members 141, 150 may be formed to include structurally-reinforcing members, such as ribs, etc., per convention.

Under normal operating conditions, the first 141 and second 150 members of latch rod 140 are generally aligned in the configuration of FIGS. 3 through 6B. Upon user actuation of the door handle 110, as explained generally above, the bellcrank 120 is rotated, driving the latch rod 140 downwardly in the direction of arrow C. This movement causes corresponding movement of the latch lever 130 (which is captured in slot 141), resulting in actuation of the latch mechanism to unlatch the vehicle door.

In response to a sufficient force associated with a side-impact event (depicted at arrow F), the latch lever 130 is urged laterally.

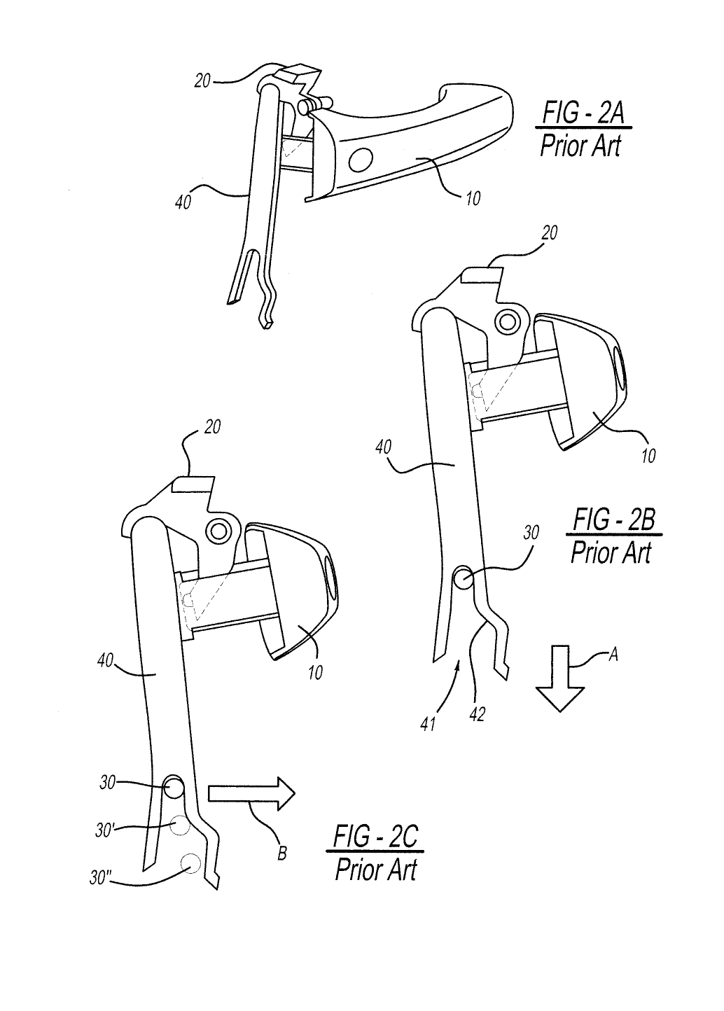

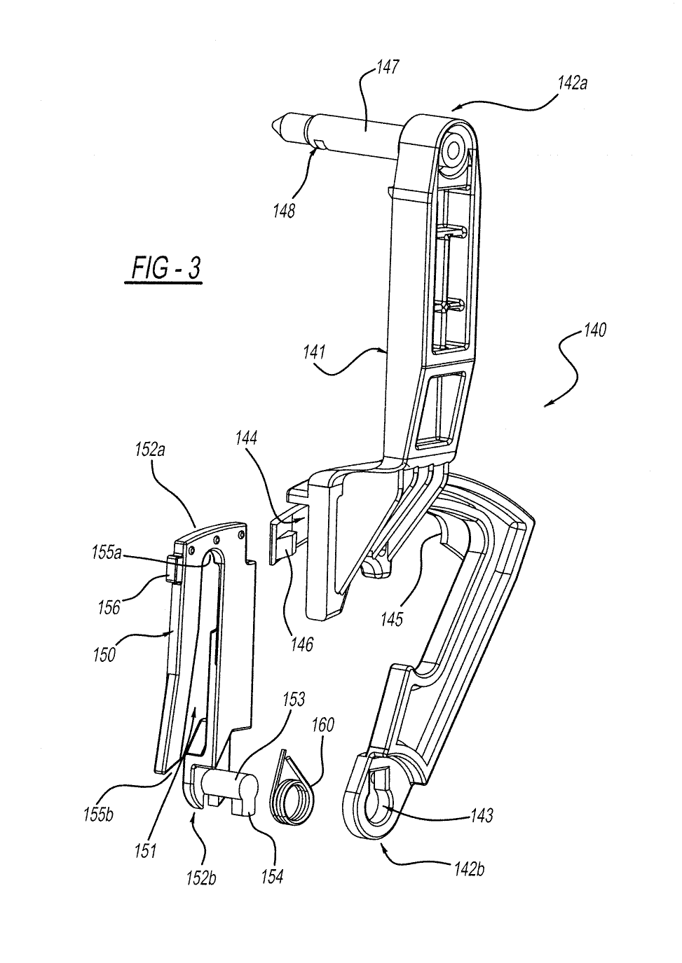

“Sufficient force,” as used in this specification, is meant to refer to such force as will cause the latch lever to move laterally with such force of its own as would otherwise (i.e., according to the latch assemblies of the prior art as described above) translate into undesirable unlatching of the vehicle door. By reason of the pivotal connection between first 141 and second 150 members, second member 150 is able to rotate away from the first member 141 (indicated by the directional arrows R1 and R2) about the axis defined by the pivotal interconnection between the first 141 and second 150 members, thereby retaining the latch lever 130 in the slot 141. As will be appreciated, such rotational movement of the second member 150 to accommodate lateral movement of the latch lever 130 keeps the latch lever 130 from confronting the sidewall of slot 141 and being urged vertically downwardly thereby, as with the prior art latch assembly described above in reference to FIGS. 2A through 2C. Thus, by the foregoing construction, the foregoing embodiment of the latch rod of this disclosure prevents the force of a side-impact event from effecting unwanted unlatching of the vehicle door.

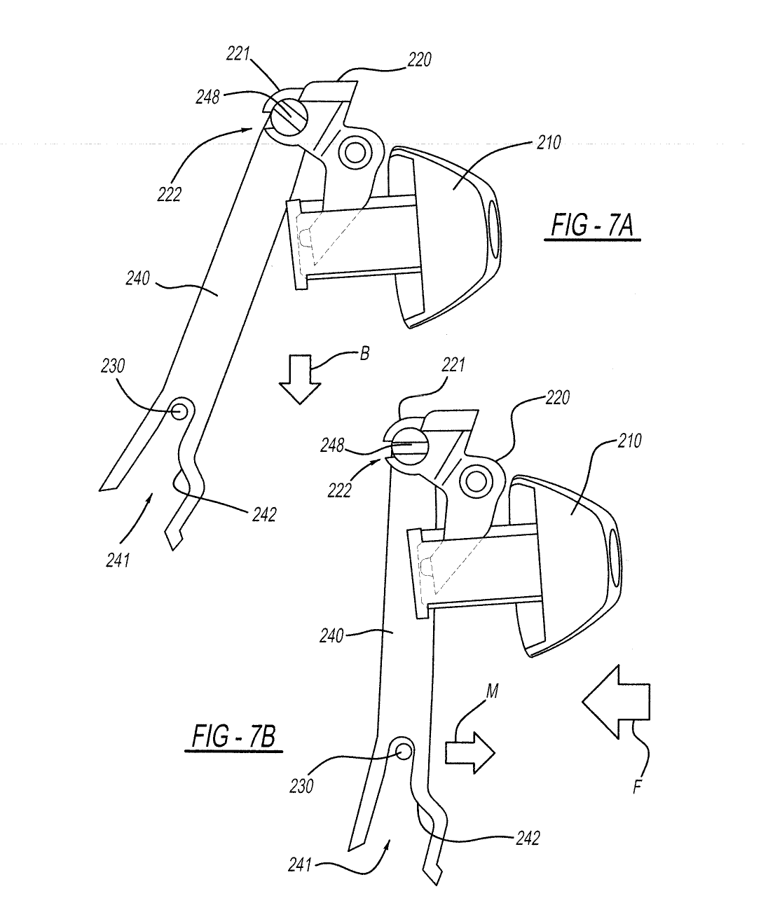

Referring now to FIGS. 7A and 7B, there is shown a second embodiment of the present invention, according to which the vehicle door latch assembly comprises a user-actuatable door handle 210 coupled to a bellcrank 220, a latch mechanism (not shown) including a latch lever 230, and a latch rod 240 coupled to the latch lever 230 and the bellcrank 220. The latch rod 240 is operable by the door handle 210 to move along a generally vertical axis (indicated by arrow C) to unlatch the latch mechanism via actuation of the latch lever 230.

As with the previous embodiment of the present invention, the latch mechanism (not shown) is of conventional design and construction.

Per the illustrated embodiment, the latch rod 240 is removably connected to the bellcrank 220 so that, in response to a sufficient force associated with a side-impact event, the latch rod 240 is disconnected from the bellcrank. More particularly, and with continuing reference to FIGS. 7A and 7B, latch rod 240 is coupled at its upper end to the bellcrank 220 in conventional fashion; except that the latch rod 240 has extending from opposite sides thereof trunnions or pins 248 (only one side is visible in FIGS. 7A and 7B) of generally rectangular cross-section, these pins or trunnions 248 being received in C-shaped supports 221. As shown, each C-shaped support 221 includes an opening 222 oriented away from the bellcrank 220. These openings 222 are each dimensioned to permit a pin or trunnion 248 to pass therethrough when properly oriented relative to each other.

Under normal operating conditions, the pins or trunnions 248 are misaligned with respect to the opening 222 in bellcrank 220, thereby ensuring that the bellcrank and latch rod 240 remain coupled. Upon user actuation of the door handle 210, the bellcrank 220 is rotated, driving the latch rod 240 downwardly in the direction of arrow C. This movement causes corresponding movement of the latch lever 230 (which is captured in slot 241), resulting in actuation of the latch mechanism to unlatch the vehicle door.

In response to a sufficient force associated with a side-impact event (depicted at arrow F), the latch lever 230 is urged laterally in the direction of arrow M. This movement results in corresponding rotational movement of latch rod 240 and, relatedly, pins or trunnions 248 within supports 221. When the pins or trunnions 248 become aligned with the openings 222 in supports 221, pins or trunnions 248 pass through openings 222 and bellcrank 220 and latch rod 240 are uncoupled. In this condition, further movement of the latch lever 230 is not translated into downward motion that would otherwise result in unwanted unlatching of the vehicle door. Thus, by the foregoing construction, this second embodiment of the present invention prevents the force of a side-impact event from effecting unwanted unlatching of the vehicle door.

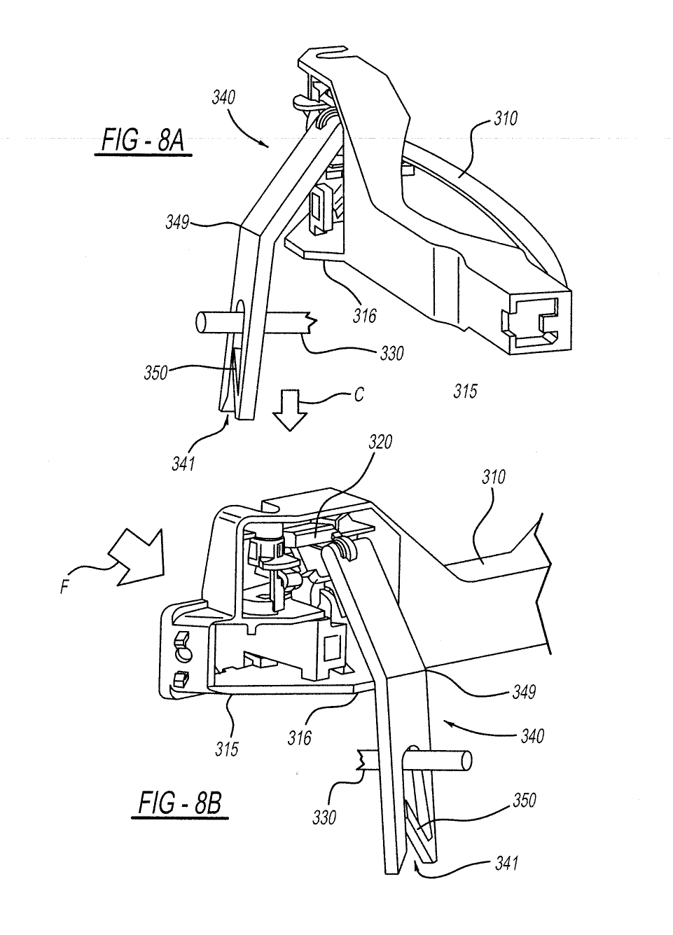

Turning now to FIGS. 8A and 8B, a third embodiment of the present inventive vehicle door latch assembly comprises a user-actuatable door handle 310 connected to a handle framework 315, a latch mechanism (not shown) including a latch lever 330 (only partially shown), and a latch rod 340 coupled to the latch lever 330 of the latch mechanism and operable by the door handle to unlatch the latch mechanism via actuation of the latch lever.

The latch mechanism (not shown) is of conventional design and construction.

According to this embodiment, the latch rod 340 is configured to be deformed by the door handle framework in response to a sufficient force associated with a side-impact event, thereby preventing unwanted actuation of the latch mechanism. More particularly, the latch rod 340 is formed to include a bend 349 along its length. Above the bend, the latch rod 340 angles toward a point of connection with a bellcrank 320 at its upper end. Below the bend 349, the latch rod 340 extends generally vertically downwardly to a free end having a slot 341 for receiving the latch lever 330. As shown, slot 341 is closed by a clip comprised of a flange 350 defining a living hinge so as to be temporarily deformable in the direction of the slot 341 in order to permit the latch lever 330 to be received and captured in the slot 341.

As depicted, the slot 341 is oriented in a plane parallel to the plane of the handle framework 315. Also according to this embodiment, the orientation of the latch lever 330 is modified from convention so that the latch lever extends toward the handle 310.

With continuing reference to FIGS. 8A and 8B, door handle framework 315 includes an inwardly (relative to the exterior of a vehicle door (not shown) to which the handle framework is mounted) projecting member 316 disposed generally in opposition to the bend 349 in latch rod 340.

Under normal operating conditions, user actuation of the door handle 310 effects rotation of bellcrank 320 which, in turn, drives the latch rod 340 downwardly in the direction of arrow C (FIG. 8A). This movement causes corresponding movement of the latch lever 330 (which is captured in slot 341), resulting in actuation of the latch mechanism to unlatch the vehicle door.

In response to a sufficient force associated with a side-impact event (shown by the arrow F), the latch rod 340 is able to move along the latch lever 330 by virtue of their mutual orientation along the axis of force vector associated with the side-impact event. Accordingly, the latch lever 330 is not urged downwardly by the latch rod 340. Furthermore, as the handle framework 315 moves inwardly under the force of the side impact event, projecting member 316 contacts and deforms (either permanently or temporarily, depending upon the material used in the fabrication, and the design of, the latch rod 340) latch rod 340 at bend 349 (where, it will be understood, latch rod is predisposed to be bent. This results in an effective reduction in the overall length of the latch rod 340, thereby preventing unwanted unlatching of the vehicle door during the side impact event. By reason of the clip, latch lever 330 remains captured in the slot 341 of latch rod 340 during the side impact event and, as the latch rod 340 is urged in the upward direction due to foreshortening by the bending process described above, positive latch of the vehicle door is maintained. Thus, by the foregoing construction, this second embodiment of the present invention prevents the force of a side-impact event from effecting unwanted unlatching of the vehicle door.

In each of the foregoing embodiments of the present invention, it is contemplated that the various components thereof may be fabricated from any suitable conventional materials, including, by way of non-limiting example, any one or more of metals and plastics or other polymers.

Many modifications and variations of the present disclosure, all of which will be apparent to those skilled in the art having the benefit of this disclosure, are possible in light of the above teachings. Therefore, within the scope of the appended claims, the present disclosure may be practiced other than as specifically described.

The invention in which an exclusive property or privilege is claimed is defined as follows:

1. A vehicle door latch assembly, comprising:
a latch lever connectable to a latch mechanism;
a latch rod coupled to the latch lever; and
a user-actuatable door handle operative to effect movement of the latch rod along a generally vertical axis to unlatch the latch mechanism via actuation of the latch lever;
wherein the latch rod is configured so as to attenuate vertical motion of the latch rod in response to a sufficient force associated with a side-impact event.

2. A latch rod for a vehicle door latch assembly of the type including a door handle operative to effect movement of the latch rod along a generally vertical axis to unlatch a latch mechanism via actuation of a latch lever, the latch rod comprising:
a first member having spaced apart upper and lower ends, and the first member adapted to be operatively connected to the door handle proximate the upper end; and
a second member having spaced apart upper and lower ends, the first and second members pivotally connected proximate their lower ends, the second member adapted to be coupled to the latch lever, and the second member being pivotally movable relative to the first member laterally in a direction away from the first member so that, in the condition of being coupled to the latch lever, the latch lever is laterally moveable with the second member.

3. The latch rod of claim 2, wherein the second member of the latch rod has generally vertically spaced-apart upper and lower ends, and comprises a generally vertically-extending slot dimensioned to receive and capture the latch lever therein, the slot opening away from the second member of the latch rod proximate the lower end.

4. The latch rod of claim 2, wherein the first member of the latch rod has generally vertically spaced-apart upper and lower ends, the second member of the latch rod has generally vertically spaced-apart upper and lower ends, and wherein the second member is pivotally connected to the first member proximate the lower ends of the first and second members.

5. The latch rod of claim 4, wherein the first member of the latch rod includes a track dimensioned to slidably receive therein a member of the upper end of the second member of the latch rod.

6. The latch rod of claim 2, wherein the first and second members of the latch rod are each monolithic.

7. The latch rod of claim 2, wherein the second member of the latch rod is pivotally movable laterally in a direction away from the first member in both first and second directions.

8. A vehicle door latch assembly, comprising:
a latch lever connectable to a latch mechanism;
a latch rod coupled to the latch lever; and
a user-actuatable door handle operative to effect movement of the latch rod along a generally vertical axis to unlatch the latch mechanism via actuation of the latch lever;
wherein the latch rod comprises a first member operatively connected to the door handle, and a second member pivotally connected to the first member, the second member coupled to the latch lever, and the second member being pivotally movable with the latch lever laterally in a direction away from the first member in response to a sufficient force associated with a side-impact event.

9. The vehicle door latch assembly of claim 8, wherein the second member of the latch rod has generally vertically spaced-apart upper and lower ends, and comprises a generally vertically-extending slot dimensioned to receive and capture the latch lever therein, the slot opening away from the second member of the latch rod proximate the lower end.

10. The vehicle door latch assembly of claim 8, wherein the first member of the latch rod has generally vertically spaced-apart upper and lower ends, the second member of the latch rod has generally vertically spaced-apart upper and lower ends, and wherein the second member is pivotally connected to the first member proximate the lower ends of the first and second members.

11. The vehicle door latch assembly of claim 10, wherein the first member of the latch rod includes a track dimensioned to slidably receive therein a member of the upper end of the second member of the latch rod.

12. The vehicle door latch assembly of claim 8, wherein the first and second members of the latch rod are each monolithic.

13. The vehicle door latch assembly of claim 8, wherein the second member of the latch rod is pivotally movable laterally in a direction away from the first member in both first and second directions.

14. A vehicle door latch assembly, comprising:
a user-actuatable door handle coupled to a bellcrank;
a latch lever; and
a latch rod coupled to the latch lever and the bellcrank, the latch rod operable by the door handle to move along a generally vertical axis to unlatch a latch mechanism via actuation of the latch lever, and the latch rod removably connected to the bellcrank; and
wherein, in response to a sufficient force associated with a side-impact event, the latch rod is disconnected from the bellcrank.

15. The vehicle door latch assembly of claim 14, wherein the bellcrank and latch rod are removably connected by interconnecting elements provided on each of the bellcrank and latch rod, the interconnecting elements characterized in that the latch rod is freely disconnected from the bellcrank only in a predefined orientation of the bellcrank and latch rod relative to each other, and only in response to a sufficient force associated with a side-impact event.

16. The vehicle door latch assembly of claim 15, wherein the interconnecting elements comprise:
at least a first support provided on one of the bellcrank and latch rod, the at least first support including an opening; and
at least a first projection provided on the other of the bellcrank and latch rod, the at least first projection received within the at least first support, the at least first projection dimensioned to be removed through the opening in the at least first support only when the at least first projection is in a predefined orientation relative to said opening.

17. The vehicle door latch assembly of claim 16, wherein the interconnecting elements comprise:
a pair of spaced-apart supports provided on one of the bellcrank and latch rod, each said support including an opening, and said openings being aligned; and
a pair of trunnions provided on the other of the bellcrank and latch rod, the trunnions received within the pair of supports, and the trunnions dimensioned to be removed through the openings in the supports only when the tunnions are in a predefined orientation relative to said openings.

18. A vehicle door latch assembly, comprising:
a user-actuatable door handle connected to a handle framework;
a latch lever; and
a latch rod coupled to the latch lever and operatively connected to the door handle, the latch rod operable by the door handle to unlatch a latch mechanism via actuation of the latch lever, the latch rod configured to be deformed by the door handle framework in response to a sufficient force associated with a side-impact event.

19. The vehicle door latch assembly of claim 18, wherein:
the latch rod comprises a generally vertically-extending slot dimensioned to receive and capture the latch lever therein, the slot defining an opening through the latch rod that is oriented so that an imaginary line extending through the opening extends in the direction of the handle; and
the latch lever including at least a terminal member that is oriented to extend through the slot;
wherein, in response to a sufficient force associated with a side-impact event, the at least terminal member of the latch lever is freely moveable within the slot along an axis extending through the opening.

20. The vehicle door latch of claim 19, wherein further the slot opens away from the latch rod proximate a lower end of the latch rod, and wherein the latch rod includes a flexible clip member extending across the open end of the slot, the flexible clip member oriented to be (i) deformable in a first direction to permit the terminal member of the latch lever to be received in the slot through the open end, and (ii) resistant to deformation in a second direction so as to prevent the terminal member of the latch lever to be removed from the slot through the open end.

21. The vehicle door latch of claim 18, wherein the latch rod is bent along its length, and wherein, in response to a sufficient force associated with a side-impact event, the door handle framework impacts the latch rod proximate the bend, causing the latch rod to deform by decreasing the angle defined along the latch rod by the bend.

22. A vehicle door latch assembly, comprising:
a user-actuatable door handle connected to a handle framework;
a latch lever; and
a latch rod coupled to the latch lever and operatively connected to the door handle, the latch rod operable by the door handle to unlatch a latch mechanism via actuation of the latch lever, the latch rod including a generally vertically-extending slot dimensioned to receive and capture the latch lever therein, the slot defining an opening through the latch rod that is oriented so that an imaginary line extending through the opening extends in the direction of the handle; and
the latch lever including at least a terminal member that is oriented to extend through the slot;
wherein, in response to a sufficient force associated with a side-impact event, the at least terminal member of the latch lever is freely moveable within the slot along an axis extending through the opening.

23. The vehicle door latch of claim 22, wherein further the slot opens away from the latch rod proximate a lower end of the latch rod, and wherein the latch rod includes a flexible clip member extending across the open end of the slot, the flexible clip member oriented to be (i) deformable in a first direction to permit the terminal member of the latch lever to be received in the slot through the open end, and (ii) resistant to deformation in a second direction so as to prevent the terminal member of the latch lever to be removed from the slot through the open end.

24. The vehicle door latch assembly of claim 22, wherein further the latch rod is configured to be deformed by the door handle framework in response to a sufficient force associated with a side-impact event.

25. The vehicle door latch of claim 24, wherein the latch rod is bent along its length, and wherein, in response to a sufficient force associated with a side-impact event, the door handle framework impacts the latch rod proximate the bend, causing the latch rod to deform by decreasing the angle defined along the latch rod by the bend.
